(19) United States
(12) Patent Application Publication
(10) Pub. No.: US 2006/0237041 A1
(43) Pub. Date: Oct. 26, 2006

(54) Food line cleaner

(76) Inventor: Donald R. Morden, Victoria (AU)

Correspondence Address: KLAUBER & JACKSON, 411 HACKENSACK AVENUE, HACKENSACK, NJ, 07601, US

(21) Appl. No.: 10/499,454

(22) PCT Filed: Dec. 23, 2002
(86) PCT No.: PCT/AU02/01745

§ 371 Date: Feb. 23, 2005

(30) Foreign Application Priority Data
Dec. 21, 2001 (AU) PR 9731

(51) Int. Cl. B08B 9/00; B08B 9/032; B08B 3/00

(52) U.S. Cl. 134/22.12; 134/22.18; 134/25.3; 134/37; 134/102.2; 134/167 C; 134/166 C

(57) ABSTRACT

A food line cleaner (1) including a pressurised water supply, a hose (12) and a nozzle (13) with the nozzle (13) attached and substantially co-linear to the end of the hose (12). Both hose (12) and nozzle (13) are sized to fit within the food line and receive pressurised water from the water supply. The nozzle includes outlets facing outwardly with at least a portion facing rearwardly to provide a forward displacement force for the hose (12). This force allows self-propelling the hose (12) and nozzle (13) through the food line for cleaning the food line.

### FIELD OF THE INVENTION

The present invention relates to an apparatus and method for cleaning a dairy milk-line system. In particular the invention relates to a mobile milk line cleaning apparatus for removing solid deposits from surfaces of a dairy milk line thereby decreasing bacteria accumulation and improving hygiene standards of a dairy milk-line system. The present invention further relates to an apparatus which can be used for cleaning and sanitizing milk lines in dairies.

### BACKGROUND OF THE INVENTION

Pipe lines, which are adapted for use as regulation standard milk harvesting equipment, through which milk is transferred or with which it is in contact are prone to bacterial contamination. Thermoduric bacteria are strong indicators of the hygiene standards employed by dairy farmers. These bacteria come from a number of places in the environment including the soil, faeces, water, milking machines and fodder. The bacteria are also present on a cow's teats. It is understood that bacteria proliferate in milk residues left in the dairy/plant (as do other types of bacteria) and increase rapidly in numbers if milk is cooled slowly, or inadequately.

At the finish of milking, bacteria can persist wherever milk residues accumulate. This is why cleaning of equipment including milk lines is so important in a dairy. High bacteria counts in a dairy farmers' milk supply impacts adversely on commercial returns as well as exposing milk consumers to unhealthy levels of bacterial contaminants.

A conventional cleaning routine performed by a farmer can involve a number of steps including sufficient hot water (temperature and volume), correct wash solutions, adequate contact time and sufficient turbulence to ensure rinsing of all surfaces so that there is no build up of milk residues and bacteria in the plant.

Milk stone or fats solids can build up in a milk-line even if only one part of the conventional cleaning routine is missed. Bacteria attach themselves to milk residue deposits and can live quite comfortably on the nutrients from the milk residues. If residues are allowed to build up, the standard cleaning routine of a dairy plant is inadequate. In such cases bacteria may survive, hidden behind build up of milk stone and fat deposits.

Historically mechanical milking machines such as “The Walk Through” were simple in design consisting of two pipes of about 1.25 inch diameter each, one being the milk line, which extracted milk from a beast and transported it to a releaser, the other pipe functioning as an air line on which pulsators were mounted. Milk and air lines were connected via pipes through releasers, vacuum tanks and sanitary traps to a vacuum pump. The plant was designed to allow thorough inspection and brush cleaning of all internal surfaces.

Through commercial necessity “walk through” milking machines evolved into a “Herringbone shed” type dairy, in which an operator is able to milk up to six to ten beasts at a time. Even more modern dairies may include rotary devices in which the capacity of milking has increased over ten fold. In a typical herringbone milking plant, the direction of pipe travel changes frequently between milk extraction and storage in both vertical and horizontal orientation. Hence the milk plant is generally constructed of many pipe sections joined by rubber elbows and sleeves; metal ‘Y’ bends; steel bends and non-return valves of various types. The array of pipes presents dairy farmers with an enormous practical problem to maintain low bacterial counts throughout the lines. To address this practical difficulty, it is known that farmers have spent days routinely dismantling all pipe work and brushing each section with long handled brushed dipped in acid.

In modern rotary dairies, the principal operation requires walking a beast onto a revolving platform which is at waist height to an operator. The milk line in a rotary dairy is always circular. By virtue of the circular construction of the milk-line, it is difficult of view inside the milk line for any practical length and indeed in most rotary plants internal surfaces cannot be viewed at all. Generally in a rotary dairy a receival can is joined to the milk line and lift pumps are positioned close by the receival can. The relative position of the can and pump is characterised by a maze of bent pipes, metal joiner clamps, connecting rubber sleeves and elbows angled hoses. Because of the array of angles and bends in a milk line dairy plant, unless thorough flushing occurs on a frequent basis, solids from the milk can deposit within the milk line by adhering to low spots or cavities on the surface of a pipe.

Once adherence of this nature has occurred, progressive build up of milk solid occurs resulting in the formation of a “milk stone”. Methods for cleaning milk lines in a dairy plant are known such as in GB patent no. 2339877 which relates to a means and method for cleaning a beer of milk-dispensing line by connecting to a milk-line and pumping a cleaning mixture through the pipeline and subsequently flushing through with clean water. Similarly US publication no. 2002/0119574 A1 and U.S. Pat. No. 4,015,618 describe and apparatus used for cleaning a dairy milk line by first connecting to a milk line and thereafter rinsing the milk line system with a cleaning fluid.

The above methods and apparatus rely on a dairy farmer to operate the machinery in order to subject the milk lines to rinsing and flushing cycles after each milking. The apparatuses described are generally very expensive and while this may preclude some dairy farmers from purchasing such an apparatus, nevertheless it still requires operator compliance.

In the event that such apparatuses are not used by an operator or indeed water is not flushed through the milk line after every milking, internal surfaces of the milk line will be prone to bacterial contamination which is not easily removed by future washing and indeed future washing may compound bacterial contamination of milk by causing some bacteria from deposited milk solids to be flushed into consumable milk during subsequent milking. Often small surface fragments of a milk stone or fatty deposit can be dislodged by milk flow exposing the milk destined for end consumers, to legions of bacteria. Not only does a contaminated batch of milk expose consumers to health risks, the presence of bacteria in milk in increasing amounts decreases a dairy farmers' income.

Other attempts have been known to address the above mentioned problems. For example in AU Patent Application No. 704681, although it is directed to determining the extent to which a milk line is cleaned, the preamble describes a conventional method of cleaning a milk line. Generally such cleaning is divided into three phases which follows each twice daily or thrice daily milking regimen:
1. Preliminary rinsing with cold to tepid water to remove milk residues. It is understood with such rinsing that it is simply not possible to remove all residue along a pipeline primarily due to the pressure drop along a given length of pipe. Therefore in general, low areas and cavities will tend to accumulate substantial milk residue or runoff;
2. The second/main rinse is usually performed with very hot water containing either an acid or more often an alkali. The purpose of the second rinse is to dissolve and remove any milk fats not flushed out by the preliminary rinse and to sanitise the surface of the pipeline. A disadvantage of implementing this phase is that residue milk solids remaining past the preliminary rinse may be susceptible to baking in the presence of hot water causing formation of a site or deposit in the pipeline from which a “milk stone” may evolve.
3. The third or post rinse phase is effected by passing hot tap water through the lines so as to eliminate traces of acid or alkali which would otherwise perish any rubber components and contaminate new milk. Tap water itself contains water borne sediments and this particularly presents a problem in the final rinse because the hot water will evaporate leaving sediment deposited on the pipe wall.

An alternative method of cleaning milk lines which has been used but might not be commonly known requires recirculation of concentrated chemicals through a line. The idea of such recirculation is based on providing greater/longer exposure of plaque material to chemical attack so that in turn greater penetration of milk stone occurs resulting in higher bacteria kill.

A major problem with this method is that
(a) higher concentration of chemical risk degradation of rubber components in a line;
(b) environmental safety is put at increased risk; and
(c) while a higher proportion of bacteria living in a stone may be killed, the flow or recirculating chemical compositions is often insufficiently turbulent to shatter of dislodge a milk stone deposit. Therefore milk stones my remain in the lines for extended periods harbouring residual bacteria.

It is therefore an object of the invention to provide an alternative apparatus and method for cleaning a milk line dairy system.

It can be seen that there has been a long felt need in the art of improving the sanitising of milk lines in dairies. It is therefore an object of the invention to provide an improved method of sanitising a milk line by effectively removing plaque deposits which overcomes the disadvantage of the prior art.

In particular it is a preferred object to provide a method of effectively removing milk stone deposits from pipes while not adversely or unduly exposing other equipment and the environment to unwarranted risk. To date there had been no effective means provided for shattering and dislodging milk stone which harbours bacteria in this way.

### SUMMARY OF THE INVENTION

According to the invention there is provided a milk line cleaning system for removing solids adhered to a surface of the line including a pressurised water supply, a flexible hose and a nozzle with the nozzle being attached and substantially co-linear to the end of the hose and both are sized to fit within the milk line and receive pressurised water from the water supply and with the nozzle including outlets facing outwardly with at least a portion facing rearwardly so as to provide a forward displacement force for the hose allowing feeding of the hose and nozzle through the milk line for cleaning the dairy milk line.

The present invention does not require the extensive flushing of a dairy milk line, such as a milk line, which consumes vast quantities of water. A particular advantage of the present invention is that the high pressure water is localised hence there is an improvement in the efficiency of removing stone (plaque) deposit and less need to use chemicals. There is also a time savings associated with localised cleaning which results in greater commercial acceptance and minimisation of production downtime. The arrangement of the nozzle allows rearward exiting of water under pressure. This arrangement serves to urge positive displacement of the hose line throughout the milk line.

A heating system can provide the pressured water supply at a temperature at or near boiling point and preferably up to about 160° C. The water supply can exit the nozzle under pressure at a rate of about 21 litres per minute. At this rate the water exiting the nozzle can act as a cutting force and as a means of displacing the hose line throughout the milk line in a direction opposite to the exiting water.

A chemical source can be connected to the hose for providing a cleaning chemical into the pressurised water supply assisting cleaning of the milk line. This can be with the chemical source being fed by a compressed air feed or magnetic pulsator injector into the pressurised water line. Alternatively the chemical source can be fed inline by the pressurised water system passing through a chemical dispensing unit.

The nozzle can be rotatably connected to the hose and including outlets shaped and located to provide a rotary action and thereby a circumferential cleaning of the inside of the milk line.

In accordance with the invention there is provided a method of removing plaque deposited on surfaces of a dairy milk transfer line including inserting a hose into an open end of said milk transfer line, said hose having an external diameter less than the internal diameter of said milk transfer line so as to enable movement of said hose through said milk line, said hose incorporating a fluid driven rotary sleeve, said sleeve having openings therein for directing jets of fluid therethrough in a rotary fashion so as to provide both a cutting effect and a means of displacing said hose, providing a source of fluid to said hoe under pressure and a means of regulating flow of fluid to said sleeve, withdrawing said hose from said line wherein when said hose is inserted in said milk transfer line said regular is activated to allow fluid under pressure to rotate said sleeve such that a first opening in said sleeve directs a first jet of fluid in a direction substantially at right angles to the direction of travel of said hose through said line and a second opening in said sleeve directs a second jet of fluid at an angle to said first jet so as to provide a forward displacement force for said hose, said hose being withdrawn from said pipe by means of applying an external force greater than the forward displacement force exerted by said second jet of fluid.

The invention further provides a method of cleaning a milk line including the steps of: providing a pressurised water supply; providing a hose sized with a diameter less than the diameter of the milk line; providing a nozzle at the end of the hose and substantially co-linear with the nozzle including outlets facing outwardly with at least a portion facing rearwardly so as to provide a forward displacement force for the hose allowing feeding of the hose and nozzle through the milk line for cleaning the milk line; inserting the hose and nozzle into the milk line and providing pressurised water from the pressurised water supply causing cleaning of the food line and progression of the hose and nozzle into the milk line.

The method of cleaning a dairy milk line can include the steps of heating the pressurised water to at or above about 160° C. or including a cleaning chemical in the pressurised water line.

The method of cleaning a milk line can include providing a cleaning chemical in the pressurised water line being provided by a compressed air supply forcing the cleaning chemical into the pressurised water feed.

The invention also provides an apparatus for removing plaque deposited on surfaces of milk transfer line including: a hose, said hose have an external diameter less than the internal diameter of said transfer lie; a rotary sleeve attached adjacent a dispensing end of said hose said sleeve incorporating openings therein for directing jets of fluid there through in a rotary fashion so as to provide both cutting and displacement means; means for providing source of fluid to said hose under pressure; means of regulating flow of said fluid to said sleeve; characterised in that a first jet of fluid is directed substantially perpendicular to the direction of travel of said hose through a transfer line and a second jet of fluid being directed at an angle to said first jet of fluid so as to provide a means of forward displacement of said hose in said transfer line.

The fluid is water containing a low sedimentary content. The apparatus can further include a heating means so as to heat the pressurised fluid before entering said hose.

The fluid can be heated by a heat exchanger upstream from the regulator to a temperature in excess of 100° C.

The sleeve includes at least two pairs of openings. The second opening preferably directs a jet of fluid at an angle of 45 from the direction of the first jet so as to provide forward propelling force.

The apparatus can further include an air compressor coupled to a chemical chamber so as to controllably inject chemical into the nozzle when desired.

The apparatus is transportable. The present invention provides not only its own means of forward movement through a milk line by directing a pair of high pressure jet sprays in a direction opposite to travel, but it primarily provides a circular cutting or scathing effect caused by directing high pressure water via jets positioned at right angles to the direction of travel.

The circular cutting effect shatters and dislodges plaque built up on the inside surface of a milk transfer line, air lines and wash lines. The angled jet spray ejects foreign material and spent water back along the pipe.

Generally the present invention ostensibly does away with hazardous chemicals, does not effect the environment, used less process steps and requires less time and labour. The positive result conferred by the present invention is reflected in the quality of milk and flow on profit to dairy farmers.

A further advantage of the present invention is that on withdrawal of the hose from the pipe line the internal surface of the pipe is assaulted for a second time. In addition farmers who have accumulated solid fat deposits on a surface of their milk transfer lines have a viable alternative to remove such contaminant.

The invention also provides a dairy milk line cleaner which is mobile including a wheeled vehicle able to be transported to a site with a food line to be cleaned; a water pressurising unit mounted on the wheeled vehicle able to receive water from a water source and powered by a power source to provide a pressurised water supply, a heating unit mounted on the wheeled vehicle receiving pressurised water from the pressurised water supply and heating the pressurised water to about 100° C; a hose and a nozzle able to be transported on the wheeled vehicle and connected to the heated pressurised water supply; with the nozzle being attached and substantially co-linear to the end of the hose and both are sized to fit within the milk transfer line and receive pressurised water from the water supply; and with the nozzle including outlets facing outwardly with at least a portion facing rearwardly so as to provide a forward displacement force for the hose allowing feeding of the hose and nozzle through the milk line for cleaning the milk line.

The mobile milk line cleaner can have the heating unit including a heat source and heat exchange mounted on the wheeled vehicle for providing the pressured water supply at a temperature at or near boiling point and preferably at or above 199° C.

A chemical source can be connected to the hose for providing a cleaning chemical into the pressurised water supply assisting cleaning of the milk line. This can be provided by an air compressor mounted on the wheeled vehicle with the chemical source being fed by a compressed air feed into the pressurised water line. Alternatively an inline chemical dispensing unit can be mounted on the vehicle and provide a chemical source into the received heated pressurised water with the chemical source being fed inline by the pressurised water system passing through a chemical dispensing unit.

The nozzle preferably is rotatably connected to the hose and including outlets shaped and located to provide a rotary action and thereby a circumferential cleaning of the inside of the milk line. In one from the nozzle includes openings directing a jet of fluid at a rearward angle of 45° from the directing of a first jet extending normal to the extension of the hose so as to provide the rotating cleaning force and the forward propelling force. In the method of the invention a hose is inserted into an open end of the milk transfer line, such that the hose has an external diameter less then the internal diameter of the milk transfer line to enable movement of the hose through a pipe line in a mobile service unit.

In a further embodiment of the invention there is disclosed a mobile milk line cleaning system for cleaning milk lines in a dairy operation, the system including:
a wheeled vehicle able to be transported to a dairy and being connectable to a milk line to be cleaned;
a water pressurising unit mounted on the wheeled vehicle adapted to receive water from a water source and powered by a power source to provide a pressurised water supply,
a heating unit mounted on the wheeled vehicle and coupled to the water pressurising unit for receiving pressurised water from the pressurised water supply, the heating unit heating the pressurised water to a temperature of about 100° C. to 160° C.;
the system further including an air compressor mounted on the vehicle and coupled to a chemical chamber to controllably inject a chemical from the chamber into the nozzle when desired;
the transportable vehicle further having mounted thereon a flexible hose and a nozzle attached thereto, the flexible hose being connected at one end to the heated pressurised water supply unit, the nozzle having a rotatable sleeve in which the sleeve includes outlets shaped and located to provide a rotary action and thereby a circumferential cleaning of the inside of the milk line with the nozzle being substantially co-linear to the end of the hose and both are sized to fit within the milk line;
the nozzle further including outlets facing outwardly with at least a portion facing rearwardly so as to provide a forward displacement force for the hose allowing feeding of the hose and nozzle through the milk line for cleaning the milk line.

In yet a further embodiment of the invention there is described a method for cleaning milk lines in a dairy operation including:
a wheeled vehicle able to be transported to a dairy and being connectable to a milk line to be cleaned, the vehicle having mounted thereon:
a water pressurising unit adapted to receive water from a water source and powered by a power source to provide a pressurised water supply,
a heating unit coupled to the water pressurising unit for receiving pressurised water from the pressurised water supply, the heating unit heating the pressurised water to a temperature of about 100° C. to 160° C.;
an air compressor coupled to a chemical chamber to enable controlled injection of a chemical from the chamber into the nozzle when desired;
a flexible hose and a nozzle attached thereto, the flexible hose being connected at one end to the heated pressurised water supply unit, the nozzle having a rotatable sleeve in which the sleeve includes outlets shaped and located to provide a rotary action and thereby a circumferential cleaning of the inside of the milk line with the nozzle being substantially co-linear to the end of the hose and both are sized to fit within the milk line;
a fluid regulator to control the flow of fluid to the rotatable sleeve;
the nozzle further including outlets facing outwardly with at least a portion facing rearwardly so as to provide a forward displacement force for the hose allowing feeding of the hose and nozzle through the milk line for cleaning the milk line;
extending the hose from the vehicle to the milk line;
inserting the hose and nozzle into the milk line and providing pressurised water from the pressurised water supply to the heating unit;
heating the pressurised water to at or above about 100° C.;
controllably actuating the air compressor to urge the cleaning chemical from the chemical chamber into the pressurised water line thereafter the chemical being available for injection into the milk line via the nozzle; and
when the regulator is activated, fluid enters the sleeve under pressure which causes rotation of the sleeve and liquid entering the sleeve exits a first opening in the form of a first jet of fluid in a direction substantially at right angles to the direction of travel of the hose through the milk line to provide a rotary action and thereby a circumferential cleaning of the inside of the milk line and a second opening in the sleeve directs a second jet of fluid at an angle to the first jet to provide a forward displacement force for the hose, the hose being withdrawn from the milk line after travelling the length of the milk line by means of applying an external force greater than the forward displacement force exerted by the second jet of fluid, thereby to rinse the milk lines with water.

In a further embodiment of the invention there is disclosed a dairy milk line cleaner which is mobile including:

a wheeled vehicle able to be transported to a site with a milk transfer line to be cleaned;

a water pressurising unit mounted on the wheeled vehicle able to receive water from a water source and powered by a power source to provide a pressurised water supply,

a heating unit mounted on the wheeled vehicle receiving pressurised water from the pressurised water supply and heating the pressurised water to about 100° C.;

a hose and a nozzle able to be transported on the wheeled vehicle and connected to the heated pressurised water supply;

with the nozzle being attached and substantially co-linear to the end of the hose and both are sized to fit within the milk line and receive pressurised water from the water supply;

and with the nozzle including outlets facing outwardly with at least a portion facing rearwardly so as to provide a forward displacement force for the hose allowing feeding of the hose and nozzle through the milk line for cleaning the milk line.

The heating unit can include a heat source and heat exchanger mounted on the wheeled vehicle for providing the pressured water supply at a temperature at or near boiling point and preferably at or above 100° C.

The mobile milk line cleaner can include a chemical source connected to the hose for providing a cleaning chemical into the pressurised water supply assisting cleaning of the milk line.

The mobile milk line cleaner can also include an air compressor mounted on the wheeled vehicle with the chemical source being fed by an compressed air feed into the pressurised water line.

The mobile milk line cleaner can further incorporate an inline chemical dispensing unit mounted on the vehicle and providing a chemical source into the received heated pressurised water with the chemical source being fed inline by the pressurised water system passing through a chemical dispensing unit.

The nozzle can be rotatably connected to the hose and including outlets shaped and located to provide a rotary action and thereby a circumferential cleaning of the inside of the milk line. The nozzle can include openings directing a jet of fluid at a rearward angle of 45° from the direction of a first jet extending normal to the extension of the hose so as to provide the rotating cleaning force and the forward propelling force. Pressurised water can exit the nozzle at a rate of about 21 litres per minute so as to exert both a cutting force and a means or propelling the hose line throughout the milk line.

### BRIEF DESCRIPTION OF THE DRAWINGS

In order that the invention is more readily understood an embodiment will be described by way of illustration only with reference to the drawings wherein:

FIG. 1 represents a schematic illustration of a first embodiment of the apparatus of the invention.

FIG. 2 represents a schematic illustration of a second modified embodiment of the apparatus of FIG. 1.

### DETAILED DESCRIPTION OF THE METHOD OF PERFORMING THE INVENTION

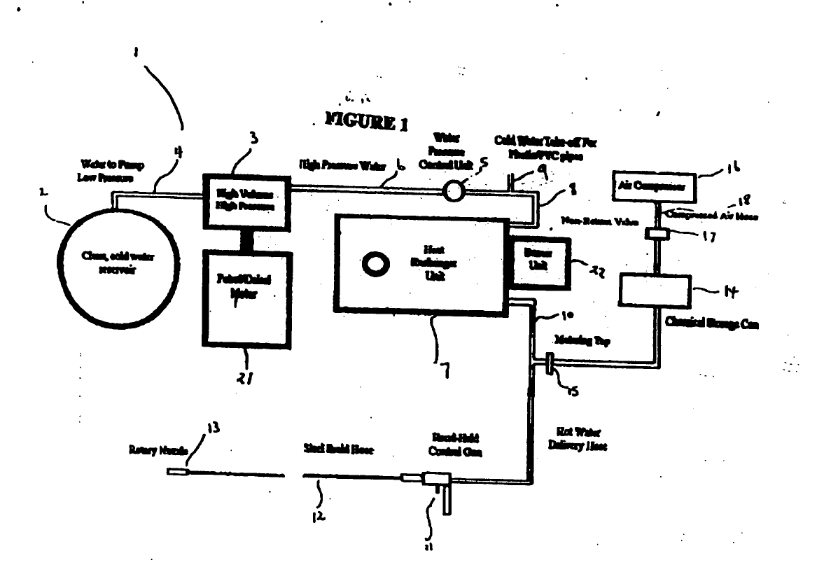

Referring to FIG. 1, there is shown a preferred embodiment wherein the milk line apparatus (1) takes the form of a mobile unit. Usually the mobile unit is understood to be a truck or trailer type conveyance on which the milk line cleaning apparatus can be easily transported for practical use at a designated site.

The milk line apparatus (1) includes a reservoir of cold water (2) which water is ordinarily pretreated to remove sedimentary material which often gives rise to undesired deposits on pipe walls. The water from the reservoir is pumped under low pressure to a high volume/high pressure station (3) by way of first connecting (4). The high pressure pump (3) is driven by a petrol or diesel motor (although not limited thereto) (21) which increased the water pressure flowing to a water pressure control unit (5) via connecting (6). The control unit (5) serves to allow excess water to flow back into the reservoir (2) under normal operating condition. When the water flow is in a non-operating condition the control unit can also relieve build up of back pressure due to water reaming in the lines.

As can be seen in FIG. 1, connection line (8) optionally includes a cold water take off (9) prior to the heat exchanger (7) for cleaning of PVC/plastic pipes controlled by conventional valve means (not shown). Alternatively after the pressure control unit there is a T-piece which can direct cold water to a separate hose reel and maintain a storage of preheated water.

Generally the heat exchange unit (7) raised the water temperature to above 100° C. The heat exchanger is operable at temperatures above 100° C. by means of a burner unit (22). At this point at 100° C. or above under pressure is releasably controlled by a hand held manually operated valve gun (11). Water exiting the valve-gun flows through a length of steel braid hose (12) which terminates in a rotary nozzle (13) at its dispensing end. The nozzle (13) incorporates a water driven sleeve adjacent the dispensing end which rotates under the influence of the high pressure water exiting the nozzle. The sleeve includes two small pairs of openings therein which first pair directs high temperature high pressure water in a plane substantially perpendicular to the direction of travel and which second pair direct water at an angle of about 45° away and back from the first pair. The rotary sleeve permits emission of water in a circular fashion and the small openings greatly increase the force of heated fluid exiting thereby to form a jet stream of high pressure water. The above combination in turn creates a very substantial cutting action, notwithstanding that the water temperature is sufficient alone to destroy living bacteria in a milk line. The high energy cutting action mentioned above readily shatters milk stone deposits and the following angled fluid jet stream washed away shattered/dislodged deposits and progressively propels the hose in a direction along the transfer line opposite to the direction of the angled stream.

FIG. 1 also shows a further optional feature whereby a chemical storage unit (14) is connected to main line (10) via a metering tap valve (15). In the event that a milk transfer line is heavily laden with milk stone deposit, a chemical such as alkali/acid treatment may be required. When metering tap (15) is opened chemical(s) is transferred into the main line under pressure from air compressor (16). The air compressor to turn is controlled by a non return vale (17) connected thereto by standard compressed air hose (18).

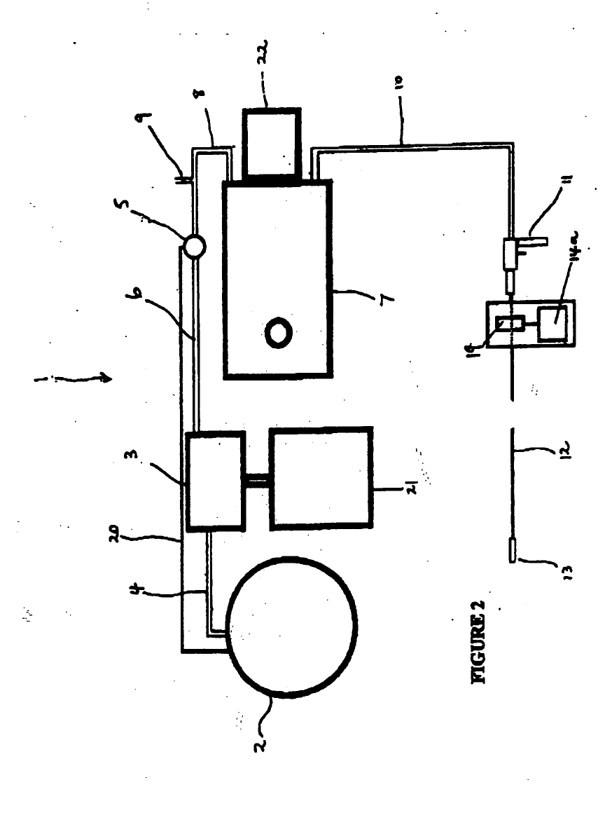

In an alternative embodiment shown with reference to FIG. 2 a chemical agent is dispensed from a portable inline chemical dispensing unit (14a). As shown dispensing unit (14a) is introduced into the apparatus after the valve gun (11) and connected to the steel braid hose (12). In this embodiment a metered quantity of chemical agent such as acid/alkali is transferred into the main line by means of a magnetic pulsator injector system (19). Alternatively, the injection system can be selected from an air compressor/metering tap, or hydraulic injector or even a venturi system. To aid the control of transfer of chemical agent into the main line the injection system (19) includes a non-return valve so as to substantially eliminate any recontamination of the resident chemical agent.

In the method of the invention the hose (12) can be a small diameter (one quarter inch) steel braid hose to confer a degree of flexibility to enable movement about a right angle bend or a sweeping bend. On one end of hose there is attached a high pressure nozzle by way of a threaded engagement. The nozzle is generally co-linear with the hose although the nozzle can be of larger diameter in order to increase the forward propulsion pressure generated as high pressure water exits the nozzle in a rearward direction. In this embodiment the nozzle is first introduced into a milk transfer line by insertion within an open end of the line. When high pressure water is supplied to the hoe line the nozzle can be actuated independently by a trigger mechanism. The nozzle contains openings to enable rearward direction of water one the trigger mechanism has be actuated. As the water exits the nozzle in a rearward direction, a propulsion force is generated in the forward direction to enable the hose line to be displaced forwardly.

As the hose is urged forward the hose line can be fed from a remote source. In order to obtain the required degree of forward propulsion of the hose line, water pressure within the hose line is controlled so that it exits the nozzle at a rate of about 21 litres per minute working at about 3000 psi. The hose internal diameter, nozzle capacity, pump volume and pressure can vary with requirements. At the exit rate of water from the nozzle the applicant unexpectedly found the high pressure water functions to effectively cut a deposited milkstone from a food line. The cutting action of exiting water is further increased if it is pulsed, hence if the nozzle is fitted with a rotating collar with strategically place openings, water can effectively be repeatedly directed to a single surface in a pulsed fashion.

It is generally understood that the external diameter of the nozzle and hose is less than the internal diameter of a milk line so that the hose/nozzle can readily move therethrough. The length of the nozzle (ferule) at the end of the hose can however limit movement about tight bends although this is addressed by restricting the length of the nozzle. For small internal diameter pipe lines the present applicant has found that if the hose exceeds a diameter of about 75% of the internal diameter of the food pipeline the efficiency of the propulsion is reduced. It should be understood however that other means of automatically urging a hose line throughout a food line are envisaged. In a further embodiment of the present invention there is provided a portable or mobile unit for washing and cleaning milk pipe lines.

An operator is required to activate the low pressure water pump so as to initially charge the high pressure/high volume pump. Alternatively in a mobile unit there is a 500 Gallon water storage unit and a high pressure water pump downstream which draws water out from the storage unit under high pressure. The high pressure pump can also be connected to a mains water supply. Water exiting the high pressure pumping station is transferred along line (8) and passes through heat exchanging unit (7) and is heated above 100° C.

Once high pressure-high temperature water leaves the heat exchanger unit, an operator controllably releases water along the hose line (12) to exit nozzle (13) by engaging valve gun (11). It is understood that the hose line (12) is displaceable within a milk transfer line by rearward propulsion provided by the aforementioned angled jet stream.

When the hose line has travelled through the length of a milk line the operator removes the hose therefrom by applying a manual force sufficient to overcome the above propulsion force. While withdrawing the hose manually an operator may still activate control valve gun (11) so that the pipe line receives a second assault during withdrawal.

In yet a further embodiment of the invention there is disclosed a portable or mobile cleaning unit which can be a vehicle on which there is mounted a water pressurizing unit and a heating unit which heats the pressurized water to about 100° C. The vehicle also includes a hose and a nozzle threaded to one end of the hose which is connectable to the heated water supply. The nozzle includes outlets facing outwardly and at least a portion being directed rearwardly so that one the hose/nozzle is inserted in a pipeline the nozzle can be actuated to release water under pressure at a rate of about 21 litres/minute in a rearward direction thereafter generating a forward propulsion force to enable the hose to move through the pipeline. As the hose move more hose is released from the vehicle. The hose is sufficiently flexible to enable forward movement through tight angled corners and bends.

1. A milk line cleaning system including a pressurised water supply, a hose and a nozzle;
with the nozzle being attached and substantially co-linear to the end of the hose and both are sized to fit within the food line and receive pressurised water from the water supply;
and with the nozzle including outlets facing outwardly with at least a portion facing rearwardly so as to provide a forward displacement force for the hose allowing feeding of the hose and nozzle through the food line for cleaning the food line.

2. A milk line cleaner according to claim 1 including a heating system for providing the pressured water supply at a temperature at or near boiling point and preferably at or above 100° C.

3. A milk line cleaner according to claim 1 including a chemical source connected to the hose for providing a cleaning chemical into the pressurised water supply assisting cleaning of the milk time.

4. A milk line cleaner according to claim 3 with the chemical source being fed by a compressed air feed into the pressurised water line.

5. A milk line cleaner according to claim 3 with the chemical source being fed inline by the pressurised water system passing through a chemical dispensing unit.

6. A milk line cleaner according to claim 1 with the nozzle being rotatably connected to the hose and including outlets shaped and located to provide a rotary action and thereby a circumferential cleaning of the inside of the milk line.

7. An apparatus for removing plaque deposited on surfaces of milk transfer line including:
a hose, said hose having an external diameter less than the internal diameter of said milk transfer line;
a rotary sleeve attached adjacent a dispensing end of said hose said sleeve incorporating openings therein for directing jets of fluid there through in a rotary fashion so as to provide both cutting and displacement means;
means for providing source of fluid to said hose under pressure;
means of regulating flow of said fluid to said sleeve;
such that a first jet of fluid is directed substantially perpendicular to the direction of travel of said hose through a transfer line and a second jet of fluid being directed at an angle to said first jet of fluid so as to provide a means of forward displacement of said hose in said milk transfer line.

8. An apparatus for removing plaque according to claim 7 wherein the fluid is water containing a low sedimentary content.

9. An apparatus for removing plaque according to claim 7 wherein the apparatus further includes a heating means so as to heat the pressurised fluid before entering said hose.

10. An apparatus for removing plaque according to claim 7 wherein the fluid is heated by a heat exchanger upstream from the regulator to a temperature in excess of 100° C.

11. An apparatus for removing plaque according to claim 7 wherein the second opening directs a jet of fluid at an angle of 45° from the direction of the first jet so as to provide forward propelling force.

12. An apparatus for removing plaque according to claim 7 wherein the apparatus further includes an air compressor coupled to a chemical chamber so as to controllably inject chemical into the nozzle when desired.

13. An apparatus for removing plaque according to claim 7 wherein the apparatus is transportable.

14. An apparatus for removing plaque according to claim 7 wherein the sleeve includes at least two pairs of openings.

15. A method of cleaning a dairy milk line including the steps of:
providing a pressurised water supply;
providing a hose sized with a diameter less than the diameter of the milk line;
providing a nozzle at the end of the hose and substantially co-linear with the nozzle including outlets facing outwardly with at least a portion facing rearwardly so as to provide a forward displacement force for the hose allowing feeding of the hose and nozzle through the food line for cleaning the milk line;
inserting the hose and nozzle into the milk line and providing pressurised water from the pressurised water supply causing cleaning of the milk line and progression of the hose and nozzle into the milk line.

16. A method of cleaning a dairy milk line according to claim 15 including the steps of:
hearing the pressurised water to at or above about 100° C.

17. A method of cleaning a milk line according to claim 16 including the steps of:
including a cleaning chemical in the pressurised water line.

18. A method of cleaning a milk line according to claim 17 with the step of including a cleaning chemical in the pressurised water line being provided by a compressed air supply forcing the cleaning chemical into the pressurised water feed.

19. A method of removing plaque deposited on surfaces of a milk transfer line including:
inserting a hose into an open end of said transfer line, said hose having an external diameter less than the internal diameter of said transfer line so as to enable movement of said hose through said line, said hose incorporating a and with the nozzle including outlets facing outwardly with at least a portion facing rearwardly so as to provide a forward displacement force for the hose allowing feeding of the hose and nozzle through the milk line for cleaning the milk line.

21. A mobile milk line cleaner according to claim 20 with the heating unit including a heat source and heat exchanger mounted on the wheeled vehicle for providing the pressured water supply at a temperature at or near boiling point and preferably at or above 100° C.

22. A mobile milk line cleaner according to claim 20 including a chemical source connected to the hose for providing a cleaning chemical into the pressurised water supply assisting cleaning of the milk line.

23. A mobile milk line cleaner according to claim 20 including an air compressor mounted on the wheeled vehicle with the chemical source being fed by an compressed air feed into the pressurised water line.

24. A mobile milk line cleaner according to claim 20 with an inline chemical dispensing unit mounted on the vehicle and providing a chemical source into the received heated pressurised water with the chemical source being fed inline by the pressurised water system passing through a chemical dispensing unit.

25. A mobile milk line cleaner according to claim 20 with the nozzle being rotatably connected to the hose and including outlets shaped and located to provide a rotary action and thereby a circumferential cleaning of the inside of the milk line.

26. A mobile milk line cleaner according to claim 20 with the nozzle including openings directing a jet of fluid at a rearward angle of 45° from the direction of a first jet extending normal to the extension of the hose so as to provide the rotating cleaning force and the forward propelling force.

27. A mobile milk line cleaner according to claim 20 wherein pressurised water exits the nozzle at a rate of about 21 litres per minute so as to exert both a cutting force and a means of propelling the hose line throughout the milk line.

28. A mobile milk line cleaning system for cleaning milk lines in a dairy operation, the system including:
a wheeled vehicle able to be transported to a dairy and being connectable to a milk line to be cleaned;
a water pressurising unit mounted on the wheeled vehicle adapted to receive water from a water source and powered by a power source to provide a pressurised water supply,
a heating unit mounted on the wheeled vehicle and coupled to the water pressurising unit for receiving pressurised water, the heating unit heating the pressurised water to a temperature of up to about 100° C.;
the transportable vehicle further having mounted thereon a flexible hose and a nozzle attached thereto;
the flexible hose being connected at one end to the water pressurizing unit for receiving heated pressurized water, said nozzle having a rotatable sleeve in which said sleeve includes outlets shaped and located to provide a rotary action and thereby a circumferential cleaning of the inside of the milk line with the nozzle being substantially co-linear to the end of the hose and both are sized to fit within the milk line;
the nozzle further including outlets facing outwardly with at least a portion facing rearwardly so as to provide a forward displacement force for the hose allowing feeding of the hose and nozzle through the milk line for cleaning the milk line.

29. A method for cleaning milk lines in a dairy operation including:
providing a wheeled vehicle able to be transported to a dairy and being connectable to a milk line to be cleaned, said vehicle having mounted thereon:
a water pressurising unit adapted to receive water from a water source and powered by a power source to provide a pressurised water supply.
a heating unit mounted on the wheeled vehicle and coupled to the water pressurising unit for receiving pressurised water, the heating unit heating the pressurised water to a temperature of up to about 100° C.;
the transportable vehicle further having mounted thereon a flexible hose and a nozzle attached thereto;
the transportable vehicle further having mounted thereon a flexible hose and a nozzle attached thereto;
an air compressor coupled to a chemical chamber to enable controlled injection of a chemical from the chamber into the nozzle when desired;
the flexible hose being connected at one end to the heated pressurised water supply unit, said nozzle having a rotatable sleeve in which said sleeve includes outlets shaped and located to provide a rotary action and thereby a circumferential cleaning of the inside of the milk line with the nozzle being substantially co-linear to the end of the hose and both are sized to fit within the milk line;
a fluid regulator to control the flow of fluid to the rotatable sleeve;
the nozzle further including outlets facing outwardly with at least a portion facing rearwardly so as to provide a forward displacement force for the hose allowing feeding of the hose and nozzle through the milk line for cleaning the milk line;
extending the hose from the vehicle to the milk line;
including the hose and nozzle into the milk line and providing pressurised water from the pressurised water supply to the heating unit;
controllably actuating the air compressor to urge the cleaning chemical from the chemical chamber into the pressurised water line thereafter the chemical being available for injection into the milk line via the nozzle; and
when the regulator is activated, fluid enters the sleeve under pressure which causes rotation of the sleeve and liquid entering the sleeve exits a first opening in the form of a first jet of fluid in a direction substantially at right angles to the direction of travel of the hose through the milk line to provide a rotary action and thereby a circumferential cleaning of the inside of the milk line and a second opening in the sleeve directs a second jet of fluid at an angle to the first jet to provide a forward displacement force for the hose, the hose being withdrawn from the milk line after travelling the length of the milk line by means of applying an external force greater than the forward displacement force exerted by the second jet of fluid, thereby to rinse the milk lines with water.
